(19) United States
(12) Patent Application Publication
(10) Pub. No.: US 2025/0052187 A1
(43) Pub. Date: Feb. 13, 2025

(54) TURBOCHARGER

(71) Applicant: BHE Turbomachinery, LLC, Portland, OR (US)

(72) Inventors: Henry K. Obermeyer, Wellington, CO (US); Mark A. Sturtevant, Portland, OR (US)

(21) Appl. No.: 18/932,495

(22) Filed: Oct. 30, 2024

Related U.S. Application Data
(63) Continuation-in-part of application No. 18/641,130, filed on Apr. 19, 2024.
(60) Provisional application No. 63/546,730, filed on Oct. 31, 2023.
(60) Provisional application No. 63/461,194, filed on Apr. 21, 2023.

(51) Int. Cl. F02B 37/02; F01D 25/30; F02B 33/40; F04D 29/42

(52) U.S. Cl. CPC F02B 37/02; F02B 33/40; F01D 25/30; F04D 29/4206

(57) ABSTRACT

A turbocharger assembly having a turbine assembly and a compressor assembly that are coupled by a rotating shaft. The turbine assembly includes an exhaust incoming-flow duct configured to deliver exhaust gases to a turbine wheel in an annular flow-path. The turbine wheel redirects and discharges the exhaust gases in a direction that is substantially opposite to the incoming exhaust flow direction. The exhaust outgoing flow passes radially inside of the annular flow-path of the exhaust incoming-flow duct. The compressor assembly includes an air incoming-flow duct configured to deliver air to an impeller wheel. The impeller wheel compresses, redirects, and discharges the air in an annular flow-path in a direction that is substantially opposite to the incoming airflow direction. The air incoming flow passes radially inside of the annular flow-path of the air outgoing-flow duct.

### CROSS-REFERENCES TO RELATED APPLICATIONS

This patent application claims the benefit of provisional Application No. 63/546,730 filed Oct. 31, 2023. This application also is a continuation in-part of U.S. patent application Ser. No. 18/641,130 filed on Apr. 19, 2024, which claims the benefit of provisional Application No. 63/461,194 filed Apr. 21, 2023. Each of those applications is incorporated into the present disclosure by this reference.

### TECHNICAL FIELD

The subject matter is related to an apparatus and methods for turbocharging internal combustion engines.

### BACKGROUND

Turbocharging of engines has been known for some time. For example, turbocharged engines have been used on internal combustion engines for cars, trucks, buses, boats, aircraft, trains, and industrial engines. Turbocharging generally provides additional power as compared to an engine that is not turbocharged and may allow use of a smaller engine (as compared to an engine without turbocharging) for a given power requirement. With turbocharging, hot and expanding engine exhaust gas is used to rotate a shaft, and the shaft is used to operate a compressor that itself draws air into the system and forces the air into the engine. This increases the mass of air and fuel in the combustion chamber.

Configurations of the disclosed technology address shortcomings in the prior art.

### BRIEF DESCRIPTION OF THE DRAWINGS

FIG. 1 is a front view of a fluid connection, according to an example configuration.

FIG. 2 is a right-side view of the fluid connection of FIG. 1.

FIG. 3 is a top view of the fluid connection of FIG. 1.

FIG. 4 is a sectional view of the fluid connection of FIG. 1, taken along the line indicated in FIG. 3.

FIG. 5 is a detail view of a portion of FIG. 4.

FIG. 6 is a perspective view of the fluid connection of FIG. 1.

FIG. 7 is a sectional view of the fluid connection of FIG. 1, taken along the line indicated in FIG. 1.

FIG. 8 is a sectional view of the fluid connection of FIG. 1, taken along the line indicated in FIG. 1.

FIG. 9 is a sectional view of the fluid connection of FIG. 1, taken along the line indicated in FIG. 1.

FIG. 10 is a sectional view of the fluid connection of FIG. 1, taken along the line indicated in FIG. 1.

FIG. 11 is a sectional view of the fluid connection of FIG. 1, taken along the line indicated in FIG. 2.

FIG. 12 is a sectional view of the fluid connection of FIG. 1, taken along the line indicated in FIG. 3.

FIG. 13 is a sectional view of the fluid connection of FIG. 1, taken along the line indicated in FIG. 3.

FIG. 14 is a perspective view of a fluid connection according to another example configuration.

FIG. 15 is a left-side view of the fluid connection of FIG. 14.

FIG. 16 is a front view of the fluid connection of FIG. 14.

FIG. 17 is a sectional view of the fluid connection of FIG. 14.

FIG. 18 is a sectional view of the fluid connection of FIG. 14, taken along the line indicated in FIG. 15.

FIG. 19 is a sectional view of the fluid connection of FIG. 14, taken along the line indicated in FIG. 16.

FIG. 20 is a perspective view of a fluid connection according to another example configuration.

FIG. 21 is a sectional view of the fluid connection of FIG. 20.

FIG. 22 is a top view of the fluid connection of FIG. 20.

FIG. 23 is a left-side view of the fluid connection of FIG. 20.

FIG. 24 is a front view of the fluid connection of FIG. 20.

FIG. 25 is a sectional view of the fluid connection of FIG. 20, taken along the line indicated in FIG. 23.

FIG. 26 is a sectional view of the fluid connection of FIG. 20, taken along the line indicated in FIG. 24.

FIG. 27 is a sectional view of an example fluid connection, illustrating guide vanes and angled fairings according to an example configuration.

FIG. 28 is a sectional view of the fluid connection of FIG. 27, taken along the line indicated in FIG. 27.

FIG. 29 is a side, sectional view of a turbocharger, according to an example configuration, and having a catalytic converter between the engine and the turbocharger.

FIG. 30 is a side, sectional view of a turbocharger, according to an example configuration, and having a catalytic converter close-coupled to the turbine side of the turbocharger.

FIG. 31 is an isometric view of the turbine blades and the turbine-inlet guide-vanes of the turbochargers of FIGS. 29 and 30.

FIG. 32 is a meridional plane view of the turbine assembly of FIGS. 29 and 30.

FIG. 33 is an isometric view of the impeller blades and the diffuser vanes of the turbochargers of FIGS. 29 and 30.

FIG. 34 is a meridional plane view of the compressor assembly of FIGS. 29 and 30.

FIG. 35 is a sectional view, as identified in FIG. 29, showing an axial section of the compressor diffuser and heat-pipe cooled diffuser vanes, according to an example configuration.

### DETAILED DESCRIPTION

As described in this document, aspects are directed to a turbocharger having a reduction in size and weight, and an increase in efficiency, when compared to previous turbochargers.

Configurations of the disclosed technology may feature two similar-appearing units-one being a turbine assembly and the other being a compressor assembly-that are disposed opposite one another and coaxially. The turbine assembly (with turbine wheel and distributor)-to which engine exhaust gas is input-acts as a turbine to power the compressor unit (with impeller and diffuser)-to which air, perhaps filtered by an air filter, is input-acts as a compressor to pressurize air for delivery to an engine. Two devices, each perhaps a fluid connection as described below, may be used to deliver flow as necessary. The design of the fluid connection may allow for inlet and outlet flow to and from the turbine that are in opposite but parallel, perhaps even co-axial, directions. Similarly, the design of the fluid connection may allow for inlet and outlet flow to and from the compressor that are in opposite but parallel, perhaps even co-axial, directions.

Efficiency gains enabled by the described technology as compared with prior art scroll-casing-type turbochargers are several. The disclosed axial compressor diffuser is generally more efficient than scroll case diffusers. This is because the axial diffuser provides a steady, uniform, and axisymmetric reduction in velocity, whereas the scroll case results in a non-axisymmetric and less uniform reduction in velocity that results in more flow separation and turbulence.

The disclosed axial compressor diffuser may be more readily adapted to also serve as an intercooler between the turbocharger compressor and the associated reciprocating internal combustion engine, enabling an engine so equipped to achieve higher efficiency and power levels by cooling the air compressed by the compressor. Turbochargers configured in accordance with the disclosed technology are generally more compact and lighter weight than those configured in accordance with prior art. This is because the turbine distributor outer diameter (OD) is no larger (or only slightly so) than the turbine OD, and the diffuser OD is no larger (or only slightly so) than the impeller OD. Such space savings may be particularly relevant in, for example, vehicles and aircraft.

The resulting savings in engine compartment space may also allow placement of an inherently exothermic, oxidative catalytic converter within the engine compartment and between the engine and the turbocharger. The heat chemically released in the exhaust gas stream by the oxidative catalytic converter—also known as a catalytic converter for oxidation (CCO)—can thus contribute to turbocharger performance and hence to overall engine performance as well.

Additionally, configurations of the disclosed technology include a fluid connection that includes a first duct and a second duct. The first duct includes a mid-portion that has a non-circular cross-section. The second end of the first duct is wholly within the second end of the second duct. The first end of the second duct is wholly outside of the first duct. As a result, configurations of the disclosed technology show improvement relative to prior art devices due to a reduction, and perhaps an elimination, of turbulent flow, and thus an increase in the extent to which flow is laminar.

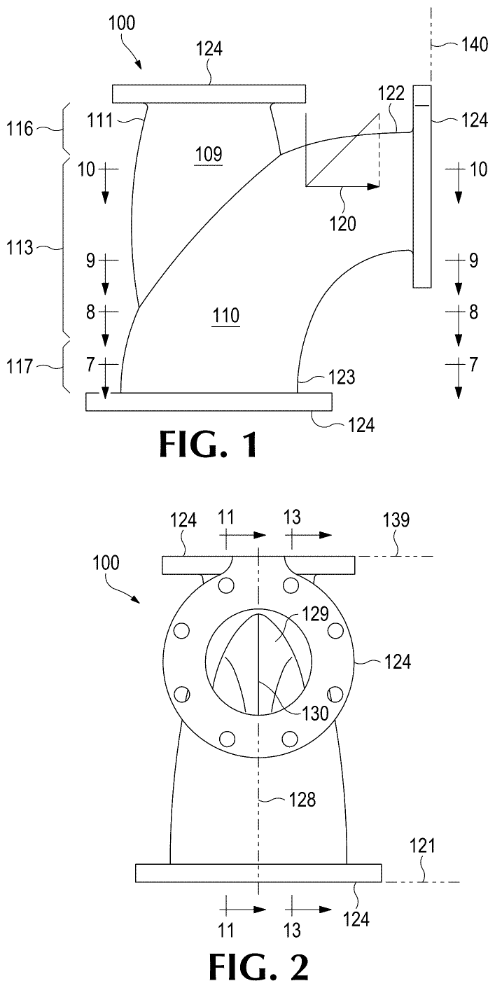

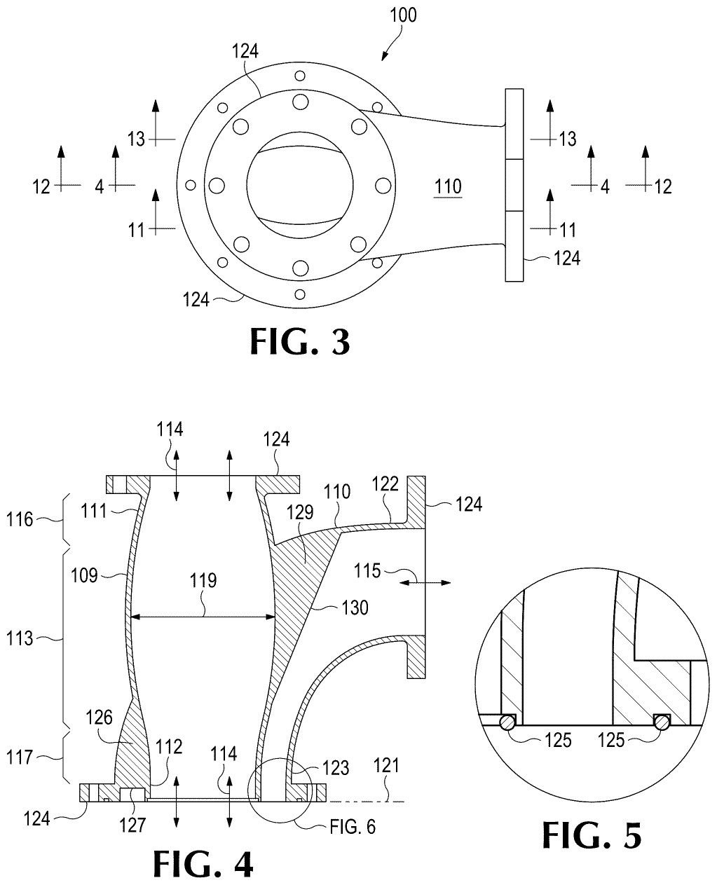

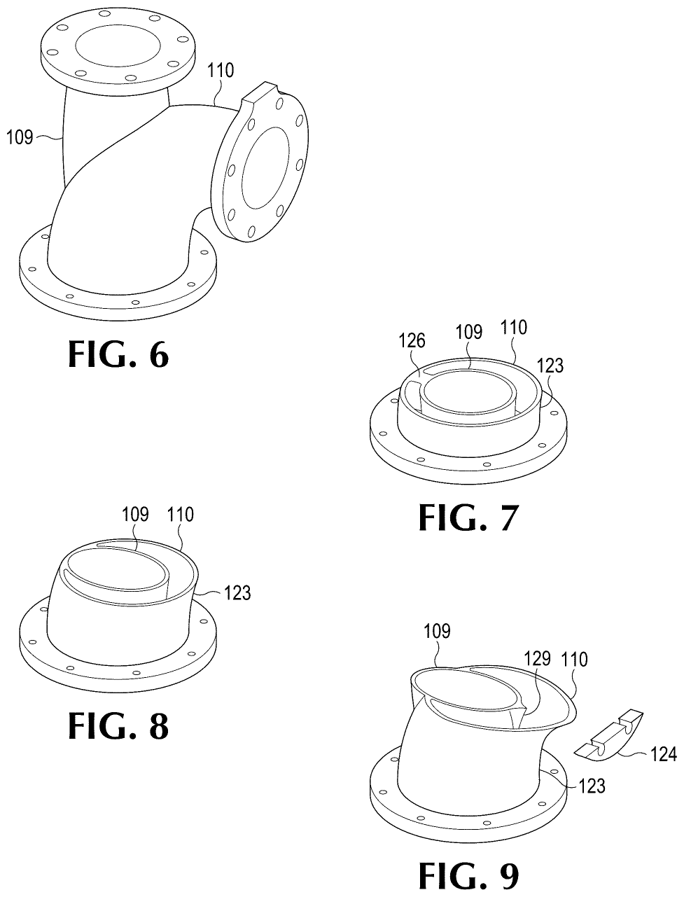

FIGS. 1-13 show various views of aspects of a fluid connection 100 for a hydromotive machine 101, according to an example configuration. The views are as described above in the Brief Description of the Drawings section. As illustrated in FIGS. 1-13, a fluid connection 100 may include a first duct 109 and a second duct 110.

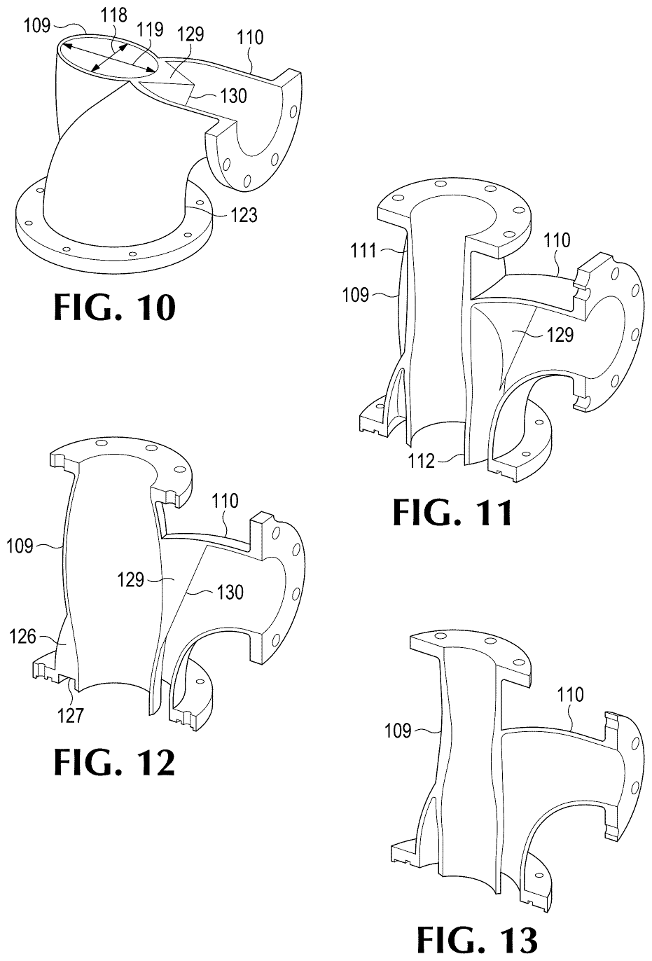

The first duct 109 extends from a first end 111 of the first duct 109 to a second end 112 of the first duct 109. The first duct 109 includes a mid-portion 113 between the first end 111 of the first duct 109 and the second end 112 of the first duct 109 that has a non-circular cross-section. FIGS. 9 and 10, in particular, illustrate an example of the non-circular cross-section. As used in this context, “non-circular” means that it is not substantially circular (as defined below). In configurations, the non-circular cross-section of the mid-portion 113 is substantially elliptical. As used in this context, “substantially elliptical” means largely or essentially having the form of an ellipse without requiring perfect ellipticalness. With regard to the first duct 109 or the second duct 110, “cross-section” or “cross section” refers to a cutting plane that is perpendicular to the primary flow direction through the duct. The primary flow direction 114 through the first duct 109, and the primary flow direction 115 through the second duct 110 are as indicated in FIG. 4. Since, in configurations, the flow can be in either direction, the flow directions are indicated in FIG. 4 with double-ended arrows.

In configurations, the first duct 109 has a substantially circular cross-section at the first end 111 of the first duct 109 and a substantially circular cross-section at the second end 112 of the first duct 109. As used in this context, “substantially circular” means largely or essentially having the form of a circle without requiring perfect roundness.

In configurations, the first end 111 of the first duct 109 has a cross-sectional flow area that is substantially equal to a cross-sectional flow area of the second end 112 of the first duct 109 and to a cross-sectional flow area of the mid-portion 113 of the first duct 109. As used in this context, “substantially equal” means largely or essentially equivalent, without requiring perfect identicalness. Stated another way, in configurations the first duct 109 includes a first portion 116 between the first end 111 of the first duct 109 and the mid-portion 113 of the first duct 109 and a second portion 117 between the second end 112 of the first duct 109 and the mid-portion 113 of the first duct 109. And the cross-sectional area of the first portion 116 is substantially equal to the cross-sectional area of the second portion 117 and to the cross-sectional area of the mid-portion 113.

In configurations, the mid-portion 113 of the first duct 109 has a width in a first direction 118 that is less than a width of the mid-portion 113 of the first duct 109 in a second direction 119, the second direction 119 being substantially perpendicular to the first direction 118. (See FIG. 10, in particular.) As used in this disclosure, “substantially perpendicular” means largely or essentially at right angles, without requiring perfect perpendicularity. In examples of such configurations, the second duct 110 extends away from the first duct 109 in a direction that has a directional component 120 that is parallel to a plane 121 defined by the second end 123 of the second duct 110. And that directional component 120 is parallel to the second direction 119. As a result, the “thinning” the first duct 109 in the first direction 118 is 90° away from the orientation that would result in the maximum obstruction of the discharge flow through the second duct 110. “Flattening” the first duct 109 in the first direction 118, while maintaining a constant duct cross-sectional area, allows fluid in the second duct 110 to be deflected less severely, and with lower losses, while passing around the first duct 109.

The second duct 110 extends from a first end 122 of the second duct 110 to a second end 123 of the second duct 110. The second end 112 of the first duct 109 is wholly within the second end 123 of the second duct 110, while the first end 122 of the second duct 110 is wholly outside of the first duct 109. In configurations, the second end 123 of the second duct 110 is coaxial with the second end 112 of the first duct 109. In configurations, the second duct 110 has a substantially circular cross-section at the first end 122 of the second duct 110 and a substantially circular cross-section at the second end 123 of the second duct 110. In the configuration illustrated in FIGS. 1-13, the substantially circular cross-section at the second end 123 of the second duct 110 is substantially annular, meaning that it largely or essentially has the form of a ring.

In configurations, such as the configuration illustrated in FIGS. 1-13, each of the first end 111 of the first duct 109, the first end 122 of the second duct 110, and the second end 123 of the second duct 110 includes a flange 124. In each case, the respective flange 124 is for coupling the fluid connection 100 to adjoining conduits or machinery. Other connection methods, such as through grooved pipe couplings 137 (discussed below), compression couplings, welded connections, adhesively bonded connections, and sanitary fittings, could also be used. Sealing at the connection between the fluid connection 100 and the adjoining piping or machinery may be by elastomeric seals 125, gaskets, or other methods.

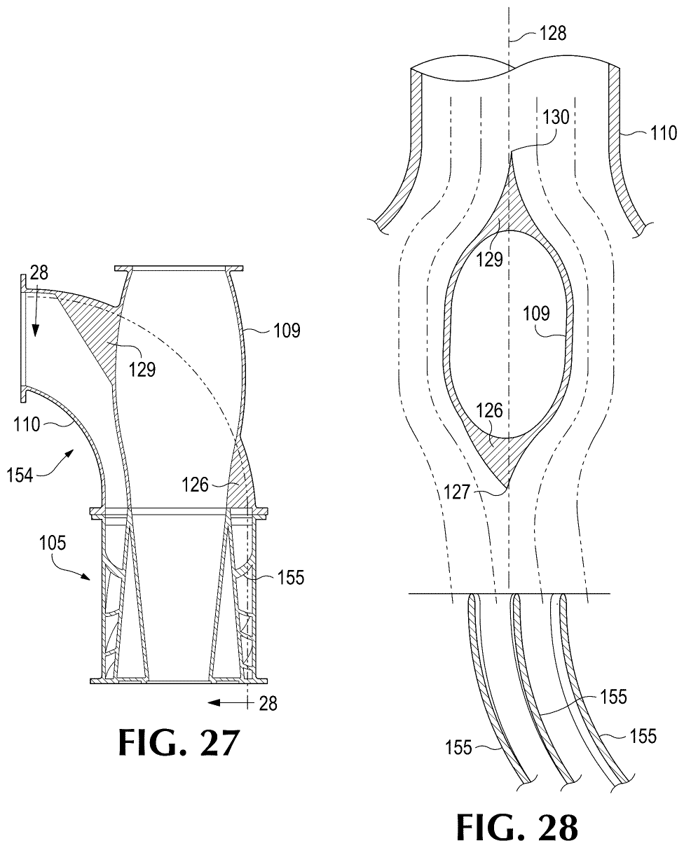

As illustrated in FIGS. 1-13, some configurations of a fluid connection 100 include a first fairing 126 within the second duct 110. The first fairing 126 includes a wedge having a vertex 127 that radially extends between the second end 112 of the first duct 109 and the second end 123 of the second duct 110. The vertex 127 broadens into the wedge as the first fairing 126 extends away from the second end 123 of the second duct 110 toward the first end 122 of the second duct 110. In configurations, the fluid connection 100 has a plane of symmetry 128 as illustrated in FIG. 2. Each of the first duct 109 and the second duct 110 is substantially symmetrical about the plane of symmetry 128. As used in this context, “substantially symmetrical” means largely or essentially having a correspondence in size, shape, and relative position of features on opposite sides of the plane of symmetry 128, without requiring perfect symmetricalness of every feature. In some configurations, the first fairing 126 is canted at an angle to the plane of symmetry 128. In some configurations, the vertex 127 of the wedge of the first fairing 126 is not on the plane of symmetry 128. Instead, the vertex 127 of the wedge of the first fairing 126 is located other than on the plane of symmetry 128 so that the first fairing 126 is not symmetrical about the plane of symmetry 128. In some configurations, the vertex 127 of the wedge of the first fairing 126 is both canted at an angle to the plane of symmetry 128 and not on the plane of symmetry 128. Examples of asymmetric fairings are illustrated in FIGS. 27-28 and described below in connection with those drawings. Asymmetric fairings of the type described here and for FIGS. 27-28 may help reduce hydraulic losses in the second duct 110.

Returning to FIGS. 1-13, in configurations the fluid connection 100 include a second fairing 129 within the second duct 110. The second fairing 129 includes a wedge that extends away from the mid-portion 113 of the first duct 109 toward the second end 123 of the second duct 110 and terminates in a vertex 130. In some configurations, the second fairing 129 is canted at an angle to the plane of symmetry 128. In some configurations, the vertex 130 of the wedge of the second fairing 129 is not on the plane of symmetry 128. Instead, the vertex 130 of the wedge of the second fairing 129 is located other than on the plane of symmetry 128 so that the second fairing 129 is not symmetrical about the plane of symmetry 128. In some configurations, the vertex 130 of the wedge of the second fairing 129 is both canted at an angle to the plane of symmetry 128 and not on the plane of symmetry 128. An example of asymmetric fairings is illustrated in FIGS. 27-28.

Returning to FIGS. 1-13, in configurations the fluid connection 100 includes the first fairing 126 and the second fairing 129. In configurations, the fluid connection 100 includes neither the first fairing 126 nor the second fairing 129. In configurations, the fluid connection 100 includes either, but not both, the first fairing 126 or the second fairing 129.

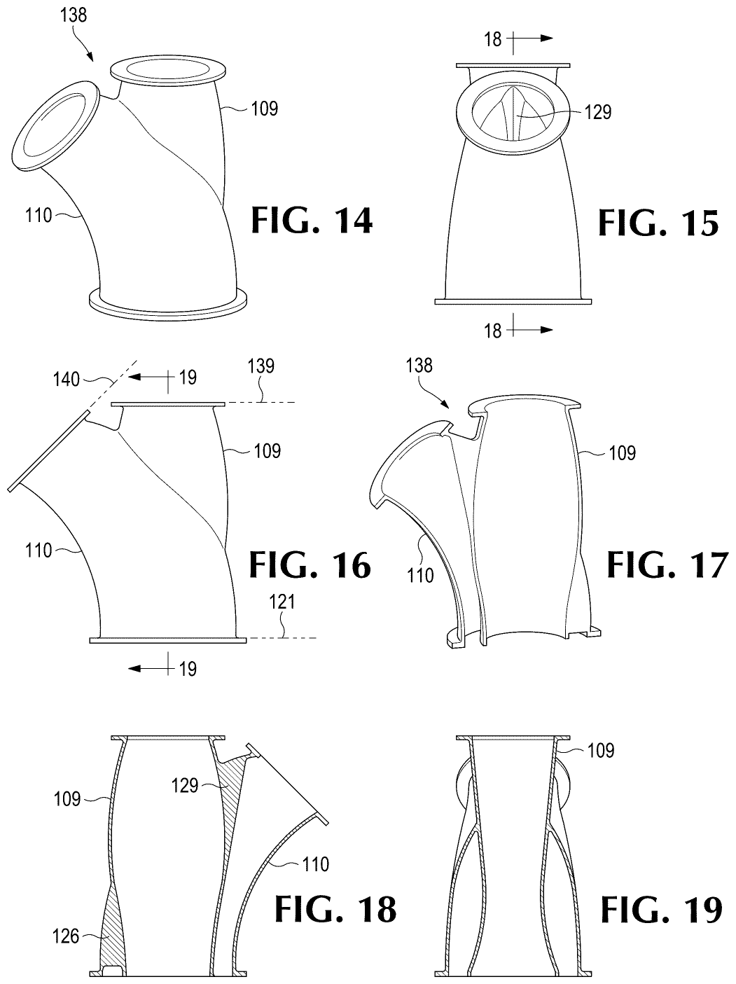

FIGS. 14-19 show various views of aspects of a fluid connection 138 for a hydromotive machine 101, according to an example configuration. The views are as described above in the Brief Description of the Drawings section. The fluid connection 138 of FIGS. 14-19 is substantially the same as the fluid connection 100 of FIGS. 1-13 except as noted here. As described more fully below, the difference between the fluid connection 138 of FIGS. 14-19 and the fluid connection 100 of FIGS. 1-13 is in the angle of the first end 122 of the second duct 110.

Specifically, a plane 139 is defined by the first end 111 of the first duct 109, another plane 140 is defined by the first end 122 of the second duct 110, and still another plane 121 is defined by the second end 123 of the second duct 110. In the configuration illustrated in FIGS. 1-13, the plane 139 of the first end 111 of the first duct 109 is substantially parallel to the plane 121 of the second end 123 of the second duct 110, and each of those planes is substantially perpendicular to the plane 140 of the first end 122 of the second duct 110. As used in this disclosure, “substantially parallel” means largely or essentially equidistant at all points, without requiring perfect parallelism. By contrast, in the configuration illustrated in FIGS. 14-19, the plane 140 of the first end 122 of the second duct 110 is not substantially perpendicular to the plane 139 of the first end 111 of the first duct 109 or to the plane 121 of the second end 123 of the second duct 110. Instead, the plane 140 of the first end 122 of the second duct 110 is at about 45° to the plane 121 of the second end 123 of the second duct 110. Even so, the 45° angle is just a typical example and other angles could also be used. In other words, the basic topology of the fluid connection can be adapted to various angles between the ducts.

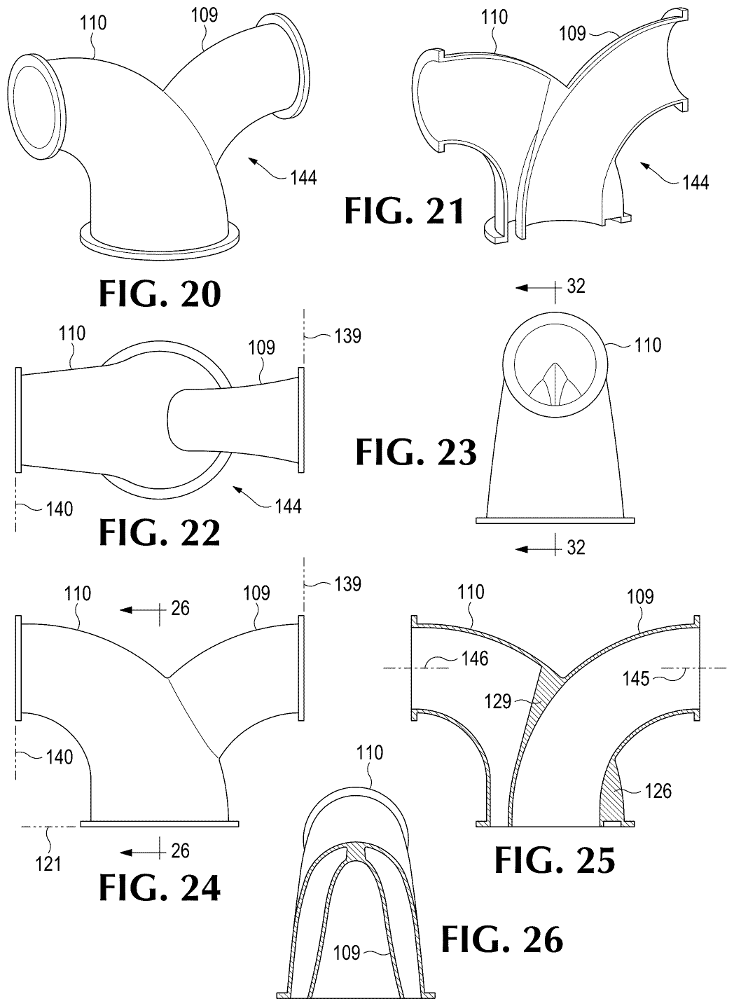

FIGS. 20-26 show various views of aspects of a fluid connection 144 for a hydromotive machine 101, according to an example configuration. The views are as described above in the Brief Description of the Drawings section. The fluid connection 144 of FIGS. 20-26 is substantially the same as the fluid connection 100 of FIGS. 1-13 except as noted here.

The difference between the fluid connection 144 of FIGS. 20-26 and the fluid connection 100 of FIGS. 1-13 is in the angle of the first end 111 of the first duct 109. Specifically, the plane 139 of the first end 111 of the first duct 109 is substantially perpendicular to the plane 121 of the second end 123 of the second duct 110. The plane 139 of the first end 111 of the first duct 109 is also substantially parallel to the plane 140 of the first end 122 of the second duct 110. And the first end 111 of the first duct 109 is coaxial with the first end 122 of the second duct 110.

Stated another way, each of the first end 111 of the first duct 109 and the first end 122 of the second duct 110 have a cross-sectional area and a centerline that passes through a midpoint of the cross-sectional area and is perpendicular to the cross-sectional area. The centerline 145 of the first end 111 of the first duct 109 and the centerline 146 of the first end 122 of the second duct 110 are collinear.

FIG. 27 is a sectional view of an example fluid connection 154 coupled to an example hydromotive machine 101, illustrating angled fairings according to an example configuration. FIG. 28 is a sectional view of the fluid connection 154 of FIG. 27, taken along the line indicated in FIG. 27. As discussed above for FIGS. 1-13, in configurations, the first fairing 126 or the second fairing 129, or both, is not symmetrical about what is otherwise the plane of symmetry 128 of the fluid connection. (See FIG. 2.) For example, as illustrated in FIG. 28, the vertex 130 of the second fairing 129 is just to the right (from the perspective in FIG. 28) of the plane of symmetry 128. As another example, while the vertex 127 the first fairing 126 is on the plane of symmetry 128, the first fairing 126 is thicker on the left side (again, from the perspective in FIG. 28) of the plane of symmetry 128. In each case, then, the fairing is asymmetrical.

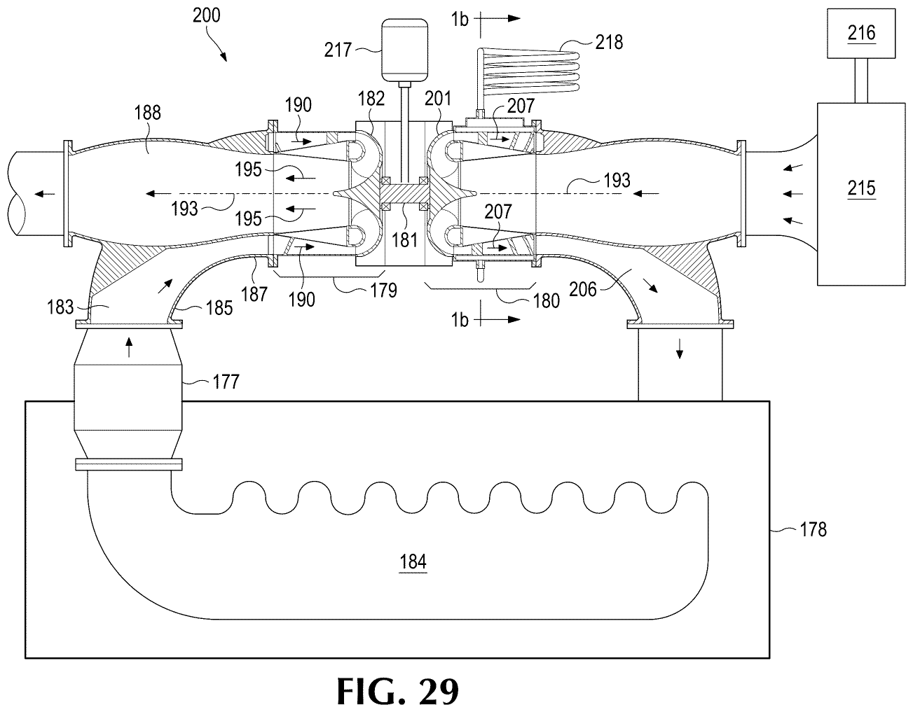

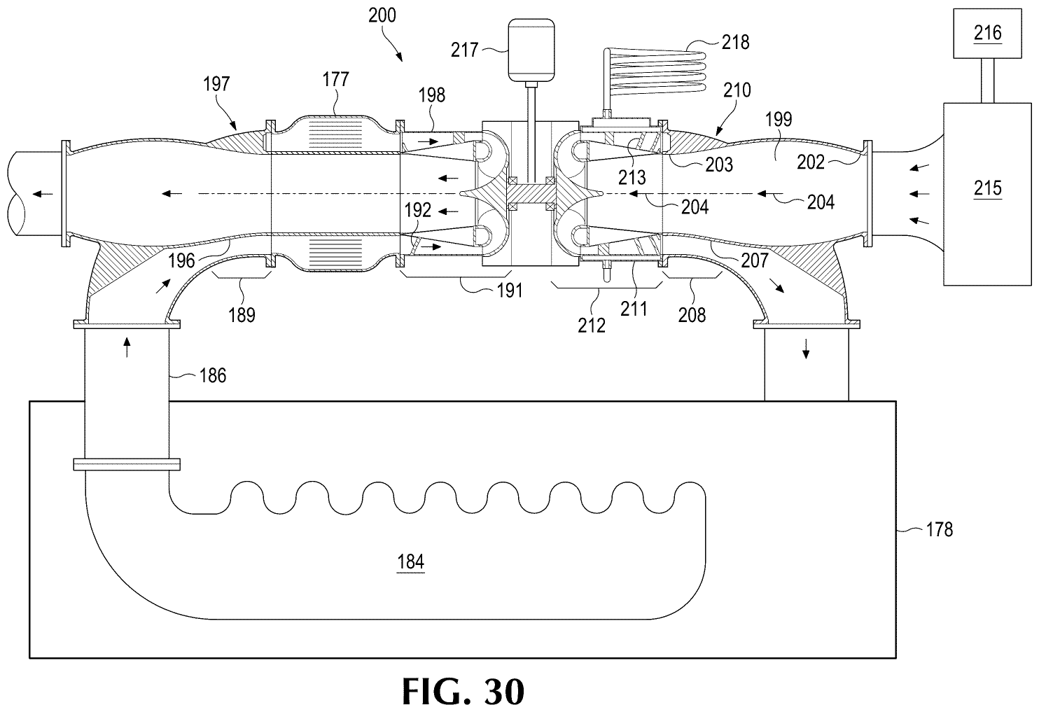

FIG. 29 is a side, sectional view of a turbocharger 200, according to an example configuration, and having a catalytic converter 177 between the engine 178 and the turbocharger 200. FIG. 30 is a side, sectional view of a turbocharger 200, according to an example configuration, and having a catalytic converter 177 close-coupled to the turbine side of the turbocharger 200. The example configurations of FIGS. 29 and 30 are identical except for the location of the optional catalytic converter 177. So, the two configurations are described together below. As illustrated in FIGS. 29 and 30, in configurations a turbocharger 200 assembly includes a turbine assembly 179, a compressor assembly 180, and a rotating shaft 181 coupling the turbine assembly 179 and the compressor assembly 180.

As illustrated in FIGS. 29 and 30, in configurations the turbine assembly 179 includes a turbine wheel 182 and an exhaust incoming-flow duct 183.

The exhaust incoming-flow duct 183 is configured to receive exhaust gases from an exhaust manifold 184 of an engine 178 at a first end 185 of the exhaust incoming-flow duct 183. For example, the first end 185 of the exhaust incoming-flow duct 183 may be directly connected to the exhaust manifold 184 of the engine 178, or the first end 185 of the exhaust incoming-flow duct 183 may be connected to other components (such as the catalytic converter 177 illustrated in FIG. 29 or the exhaust conduit 184 illustrated in FIG. 30) that are between the exhaust manifold 184 and the first end 185 of the exhaust incoming-flow duct 183. The exhaust incoming-flow duct 183 is further configured to deliver the exhaust gases at a second end 187 of the exhaust incoming-flow duct 183 to the turbine wheel 182 (either directly or indirectly through the distributor 191 described below). As illustrated, the exhaust gases are delivered in an annular flow-path because the exhaust incoming-flow duct 183 surrounds, in an annular fashion, the exhaust outgoing-flow duct 188 (described below). The annular flow-path is at an annular-flow-path portion 189 of the exhaust incoming-flow duct 183. As illustrated, the exhaust gases are delivered in a first direction 190 of the turbine assembly 179.

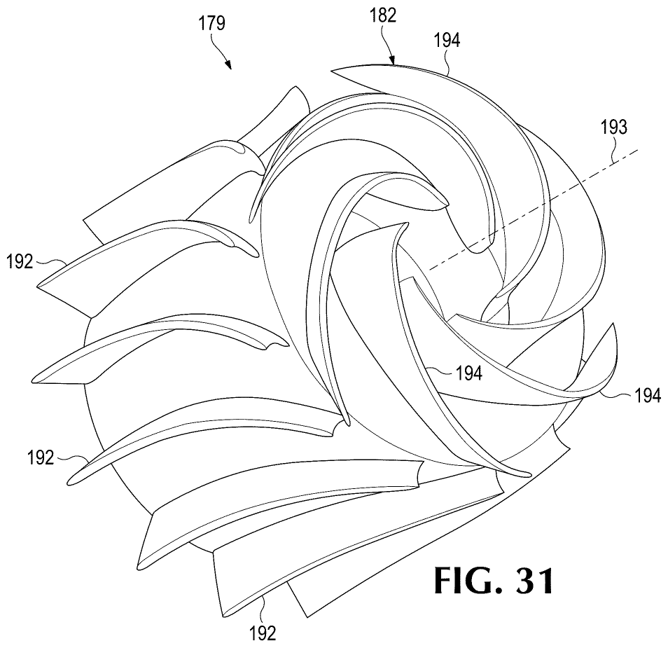

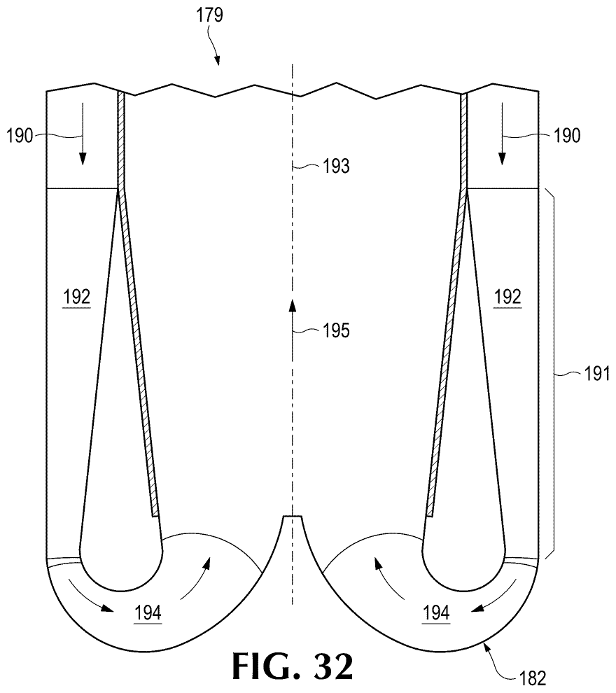

In the illustrated configuration, the exhaust incoming-flow duct 183 delivers the exhaust gases to the turbine wheel 182 through a distributor 191 that is between the second end 187 of the exhaust incoming-flow duct 183 and the turbine wheel 182. The distributor 191 may also function as a compressor for the turbine assembly 179 by compressing the exhaust gases before the exhaust gases reach the turbine wheel 182. The distributor 191 may include turbine-inlet guide-vanes 192, which are explained further below with regard to FIGS. 31 and 32. In the illustrated configuration, the distributor 191, including the turbine-inlet guide-vanes 192, does not rotate about the axis of rotation 193.

The turbine wheel 182 is configured to rotate about an axis of rotation 193. The first direction 190 of the turbine assembly 179 is substantially parallel to the axis of rotation 193. As used in this disclosure, “substantially parallel” means largely or essentially equidistant at all points, without requiring perfect parallelism. As illustrated, the turbine wheel 182 has turbine blades 194 that are configured to accept the exhaust gases from the exhaust incoming-flow duct 183, redirect the exhaust gases, and then discharge the exhaust gases along an exhaust outgoing-flow duct 188. The exhaust gases are discharged in a second direction 195 of the turbine assembly 179 that is substantially opposite to the first direction 190 of the turbine assembly 179. As used in this context, “substantially opposite” means largely or essentially diametric and parallel, without requiring perfect contrariness or parallelism. The exhaust outgoing-flow duct 188 passes radially inside of an inner boundary 196 of the annular-flow-path portion 189 of the exhaust incoming-flow duct 183. This is explained further below with regard to FIGS. 31 and 32.

In the above description of the turbine assembly 179, the exhaust incoming-flow duct 183 and the exhaust outgoing-flow duct 188 may be part of a fluid connection 197. The fluid connection 197 of FIGS. 29 and 30 may be any of the fluid connection 100 of FIGS. 1-13, the fluid connection 138 of FIGS. 14-19, the fluid connection 144 of FIGS. 20-26, or the fluid connection 154 of FIGS. 27-28. In such configurations, the exhaust incoming-flow duct 183 corresponds to the second duct 110, and the exhaust outgoing-flow duct 188 corresponds to the first duct 109. Accordingly, in such configurations, the exhaust outgoing-flow duct 188 includes a mid-portion between the first end of the exhaust outgoing-flow duct 188 and the second end of the exhaust outgoing-flow duct 188 that has a non-circular cross-section. In configurations, the non-circular cross-section of the mid-portion is substantially elliptical. In configurations, a width of the mid-portion of the exhaust outgoing-flow duct 188 in a third direction (corresponding to the first direction 118 illustrated in FIG. 10) is less than a width of the mid-portion of the exhaust outgoing-flow duct 188 in a fourth direction (corresponding to the first direction 118 illustrated in FIG. 10), the third direction being substantially perpendicular to the fourth direction. The exhaust incoming-flow duct 183 extends from a first end 185 of the exhaust incoming-flow duct 183 to a second end 187 of the exhaust incoming-flow duct 183. The second end of the exhaust outgoing-flow duct 188 is wholly within the second end 187 of the exhaust incoming-flow duct 183. The first end 185 of the exhaust incoming-flow duct 183 is wholly outside of the exhaust outgoing-flow duct 188.

FIG. 31 is an isometric view of the turbine assembly 179 of FIGS. 29 and 30, except that the outer wall 198 of the distributor 191 is not shown so that the turbine blades 194 and the turbine-inlet guide-vanes 192 may be seen. In the illustrated configuration, the turbine blades 194 rotate about the axis of rotation 193 while the turbine-inlet guide-vanes 192 do not. FIG. 32 is a meridional-plane view of the turbine assembly 179 of FIGS. 29 and 30. As illustrated in FIGS. 31 and 32, the turbine-inlet guide-vanes 192 turn (in a tangential direction) as the exhaust gases flow past the turbine-inlet guide-vanes 192. The turbine-inlet guide-vanes 192 accelerate the exhaust gases and deliver the exhaust gases to the outer perimeter of the turbine wheel 182, where the exhaust gases forcibly rotate the turbine blades 194 of the turbine wheel 182. The turbine-inlet guide-vanes 192 may be made sufficiently long to avoid flow separation and provide a uniform blade-to-blade axial velocity. Furthermore, the illustrated arrangement of the turbine-inlet guide-vanes 192 provides an inherently axisymmetric approach flow of the exhaust gases to the turbine wheel 182. As illustrated, the turbine blades 194 direct the flow of exhaust gases radially (with the tangential component reduced) and inward towards the axis of rotation 193. In the illustrated configuration, the turbine blades 194 also reverse the direction of the exhaust gases by 180 degrees, from the first direction 190 of the turbine assembly 179 to the second direction 195 of the turbine assembly 179. Accordingly, since the exhaust gases are directed towards the axis of rotation 193 and then reversed in direction, the exhaust gases in the exhaust outgoing-flow duct 188 pass radially inside of the annular-flow-path portion 189 of the exhaust incoming-flow duct 183.

Returning to FIGS. 29 and 30, in configurations the compressor assembly 180 includes an air incoming-flow duct 199 and an impeller wheel 201 that is configured to rotate about the axis of rotation 193.

The air incoming-flow duct 199 is configured to receive air at a first end 202 of the air incoming-flow duct 199 and to deliver the air at a second end 203 of the air incoming-flow duct 199 to the impeller wheel 201. The air incoming-flow duct 199 delivers the air in a first direction 204 of the compressor assembly 180, the first direction being substantially parallel to the axis of rotation 193.

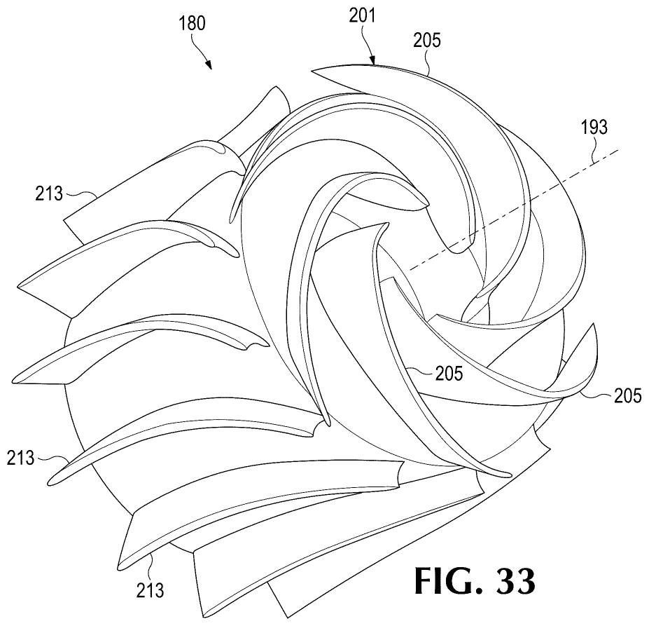

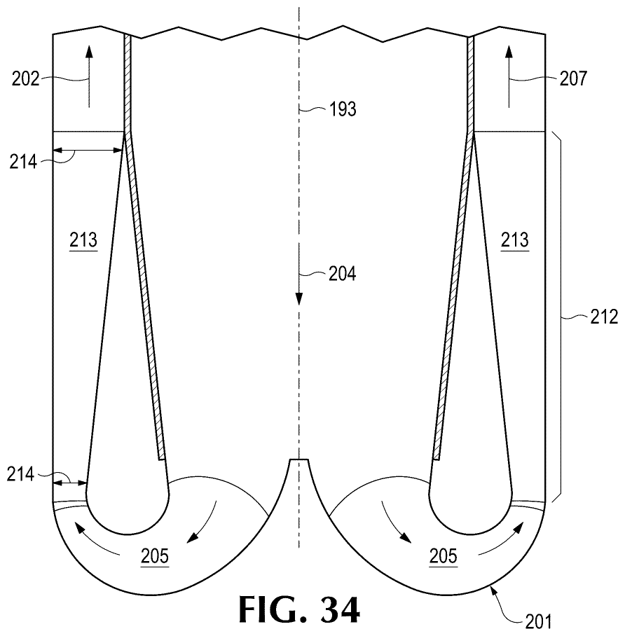

The impeller wheel 201 has impeller blades 205 that are configured to accept the air from the air incoming-flow duct 199, compress and redirect the air (as explained further below with regard to FIGS. 33 and 34), and discharge the air along an air outgoing-flow duct 206 (either directly or indirectly through a diffuser 212 between the impeller wheel 201 and the outgoing-flow duct 206). The air is discharged in an annular flow-path and in a second direction 207 of the compressor assembly 180, where the second direction is substantially opposite to the first direction 204 of the compressor assembly 180. The annular flow-path is at an annular-flow-path portion 208 of the air outgoing-flow duct 206. The air incoming-flow duct 199 passes radially inside of an inner boundary 209 of the annular-flow-path portion 208 of the air outgoing-flow duct 206. This is explained further below with regard to FIGS. 33 and 34.

In the above description of the compressor assembly 180, the air incoming-flow duct 199 and the air outgoing-flow duct 206 may be part of a fluid connection 210. The fluid connection 210 of FIGS. 29 and 30 may be any of the fluid connection 100 of FIGS. 1-13, the fluid connection 138 of FIGS. 14-19, the fluid connection 144 of FIGS. 20-26, or the fluid connection 154 of FIGS. 27-28. In such configurations, the air incoming-flow duct 199 corresponds to the first duct 109, and the air outgoing-flow duct 206 corresponds to the second duct 110. Accordingly, in such configurations, the air incoming-flow duct 199 includes a mid-portion between the first end 202 of the air incoming-flow duct 199 and the second end 203 of the air incoming-flow duct 199 that has a non-circular cross-section. In configurations, the non-circular cross-section of the mid-portion is substantially elliptical. In configurations, a width of the mid-portion of the air incoming-flow duct 199 in a fifth direction (corresponding to the first direction 118 illustrated in FIG. 10) is less than a width of the mid-portion of the air incoming-flow duct 199 in a sixth direction (corresponding to the second direction 119 illustrated in FIG. 10), the sixth direction being substantially perpendicular to the fifth direction. The air outgoing-flow duct 206 extends from a first end of the air outgoing-flow duct 206 to a second end of the air outgoing-flow duct 206. The second end of the air outgoing-flow duct 206 is wholly within the second end 203 of the air incoming-flow duct 199. The first end of the air outgoing-flow duct 206 is wholly outside of the air incoming-flow duct 199.

FIG. 33 is an isometric view of the compressor assembly 180 of FIGS. 29 and 30, except that the outer wall 211 of the diffuser 212 is not shown so that the impeller blades 205 and the diffuser vanes 213 can be seen. FIG. 34 is a meridional plane view of the compressor assembly 180 of FIGS. 29 and 30. As illustrated in FIGS. 33 and 34, the impeller draws air into the impeller when the impeller blades 205 rotate. The air is drawn in near the axis of rotation 193. The impeller blades 205 then turn the 180 degrees—from the first direction 204 of the compressor assembly 180 to the second direction 207 of the compressor assembly 180—while also imparting a tangential component of motion to the air. Flow output from the impeller (specifically, from the outer perimeter of the rotating impeller blades 205) then passes to a stationary diffuser 212. In configurations, the diffuser 212 also includes diffuser vanes 213. As illustrated, the diffuser vanes 213 may be curved to reduce tangential velocity of the airflow, converting the airflow into pressure under conservation of energy principles.

The diffuser 212 reduces the tangential component of the impelled air and decelerates the flow by expanding the area through which the flow passes. The flow area is expanded, for example, by an increase in the radial width 214 of the annular passageways between the diffuser vanes 213 of the diffuser 212. As best illustrated in FIG. 34, the radial width 214 of the annular passageways between the diffuser vanes 213 of the diffuser 212 is narrower near the impeller and wider away from the impeller. Accordingly, the diffuser 212 converts kinetic energy of the impelled fluid to pressure. The flow output from the diffuser 212 may then (either directly or indirectly through other components) be directed by pressure into the engine 178, for example, into the cylinders of an internal combustion engine.

Returning to FIGS. 29 and 30, in configurations, the compressor assembly 180 includes an air filter 215 at the first end 202 of the air incoming-flow duct 199. Versions of such configurations also include a water supply 216 to provide water to the air filter 215 for the purpose of evaporative cooling of the air as the air passes through the filter.

The rotating shaft 181 is coupled to the turbine wheel 182 and to the impeller wheel 201. The rotating shaft 181 coincides with the axis of rotation 193. Accordingly, the rotating motion of the turbine wheel 182 is transferred to the impeller wheel 201 via the rotating shaft 181. In configurations, the turbocharger 200 assembly also includes an electric motor 217 coupled to the rotating shaft 181, and the motor 217 is configured to rotate the rotating shaft 181 and, thereby, rotate the turbine wheel 182. Accordingly, in addition to being rotated by the flow of the exhaust gases, the turbine wheel 182 may also be rotated by the motor 217 or by the engine 178 (for example, through a mechanical connection to the engine 178), or both, to provide a boosted turbine effect. In configurations, the motor 217 also or instead is configured to rotate the shaft 181 and, thereby, rotate the impeller wheel 201. Accordingly, in addition to being rotated by the turbine wheel 182 via the shaft 181, the impeller wheel 201 may also be rotated by the motor 217 or by the engine 178 (for example, through a mechanical connection to the engine 178), or both, to provide a supercharger effect. In other configurations, the turbine wheel 182 or the impeller wheel 201, or both, may be driven by an additional power source other than the electric motor 217, such as a gas turbine (other than the turbine assembly 179 of the turbocharger 200 itself).

In configurations, the turbocharger 200 assembly may include a catalytic converter 177. As illustrated in FIG. 29, the catalytic converter 177 may be between the first end 185 of the exhaust incoming-flow duct 183 and the exhaust manifold 184 of the engine 178. As illustrated in FIG. 30, the catalytic converter 177 may be between the second end 187 of the exhaust incoming-flow duct 183 and the turbine assembly 179. Configurations having catalytic converters take advantage of exhaust gas temperature rise within the catalytic converter 177. Additionally, for the configuration illustrated in FIG. 30, the exhaust heated through the catalytic converter 177 enters the turbine wheel 182 with less travel than the configuration of FIG. 29 (because the catalytic converter 177 is closer to the turbine wheel 182 in the configuration illustrated in FIG. 30). This reduces heat loss and, thus, the need for exhaust pipe insulation. Furthermore, in configurations the flow channels within the catalytic converter 177 can be oriented to impart angular momentum to the exhaust gas stream, reducing the angular momentum that the turbine distributor 191 must impart on the gas stream. Such a configuration allows for a reduction in the size of the turbine distributor 191.

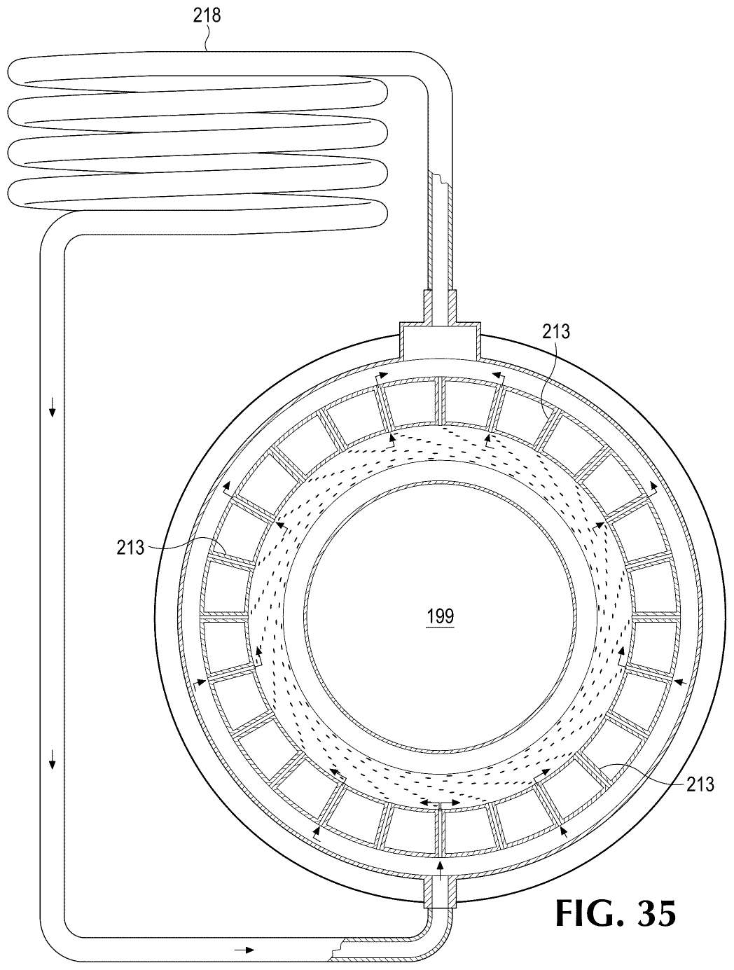

FIG. 35 is a sectional view, as identified in FIG. 29, showing an axial section of the compressor diffuser 212 and heat-pipe cooled diffuser vanes 213, according to an example configuration. As illustrated in FIGS. 29, 30, and 35, configurations of a turbocharger 200 assembly may include an intercooler heat-pipe condenser 218. In such configurations, the diffuser vanes 213 are cooled by the intercooler heat-pipe condenser 218. In other configurations, the diffuser vanes 213 may be cooled by means of a circulated fluid. Accordingly, air exiting the impeller is cooled as it passes through the diffuser 212. Such configurations increase the mass flow rate of the compressed air supplied to the engine 178 over configurations that do not cool the air after it is compressed.

Note that while the illustrated configurations show use of both the turbine blades 194 and the turbine-inlet guide-vanes 192 illustrated in FIG. 31 and the impeller blades 205 and the diffuser vanes 213 illustrated in FIG. 33, some configurations will include one but not the other. For example, a configuration may include the turbine blades 194 and the turbine-inlet guide-vanes 192 illustrated in FIG. 31 along with a conventional impeller and diffuser 212. Similarly, a configuration may include the impeller blades 205 and the diffuser vanes 213 illustrated in FIG. 33 along with a conventional turbine.

Since the axial-in, axial-out designs of the turbine assembly 179 or the compressor assembly 180, or both, lack the scroll cases of conventional turbines and compressors having radial input or output, the turbocharger 200 of the present disclosure occupies less space than a conventional turbocharger that has the same flowrate of air or exhaust gases through the turbocharger.

Additionally, the non-rotating axial diffuser 212 or distributor 191, as compared with conventional apparatuses, (a) reduces or even eliminates turbulent flow, thereby reducing generated noise or improving efficiency; (b) avoids unacceptably high flow pressure gradients, thereby reducing generated noise or improving efficiency; (c) converts more kinetic energy into pressure (as opposed to heat) when acting as a diffuser; (d) and may be radially no larger than the corresponding impeller or turbine wheel 182.

### Examples

Illustrative examples of the disclosed technologies are provided below. A particular configuration of the technologies may include one or more, and any combination of, the examples described below.

Example 1 includes a turbocharger assembly comprising: a turbine assembly comprising: a turbine wheel configured to rotate about an axis of rotation, an exhaust incoming-flow duct configured to receive exhaust gases from an exhaust manifold of an engine at a first end of the exhaust incoming-flow duct and to deliver the exhaust gases at a second end of the exhaust incoming-flow duct to the turbine wheel in an annular flow-path and in a first direction of the turbine assembly that is substantially parallel to the axis of rotation, the annular flow-path being at an annular-flow-path portion of the exhaust incoming-flow duct, and the turbine wheel having turbine blades configured to accept the exhaust gases from the exhaust incoming-flow duct, redirect the exhaust gases, and discharge the exhaust gases along an exhaust outgoing-flow duct in a second direction of the turbine assembly that is substantially opposite to the first direction of the turbine assembly, the exhaust outgoing-flow duct passing radially inside of an inner boundary of the annular-flow-path portion of the exhaust incoming-flow duct; a rotating shaft coupled to the turbine wheel, the rotating shaft coinciding with the axis of rotation; and a compressor assembly comprising: an impeller wheel configured to rotate about the axis of rotation, the impeller wheel being coupled to the rotating shaft, an air incoming-flow duct configured to receive air at a first end of the air incoming-flow duct and to deliver the air at a second end of the air incoming-flow duct to the impeller wheel in a first direction of the compressor assembly that is substantially parallel to the axis of rotation, and the impeller wheel having impeller blades configured to accept the air from the air incoming-flow duct, compress and redirect the air, and discharge the air along an air outgoing-flow duct in an annular flow-path in a second direction of the compressor assembly that is substantially opposite to the first direction of the compressor assembly, the annular flow-path being at an annular-flow-path portion of the air outgoing-flow duct, the air incoming-flow duct passing radially inside of an inner boundary of the annular-flow-path portion of the air outgoing-flow duct.

Example 2 includes the turbocharger assembly of Example 1, further comprising a catalytic converter within the exhaust incoming-flow duct.

Example 3 includes the turbocharger assembly of any of Examples 1-2, further comprising a catalytic converter between the first end of the exhaust incoming-flow duct and the exhaust manifold of the engine.

Example 4 includes the turbocharger assembly of any of Examples 1-3, further comprising a motor coupled to the rotating shaft, the motor configured to rotate the rotating shaft and, thereby, rotate the turbine wheel.

Example 5 includes the turbocharger assembly of any of Examples 1-4, in which the exhaust outgoing-flow duct includes a mid-portion between the first end of the exhaust outgoing-flow duct and the second end of the exhaust outgoing-flow duct that has a non-circular cross-section; and in which the exhaust incoming-flow duct extends from a first end of the exhaust incoming-flow duct to a second end of the exhaust incoming-flow duct, the second end of the exhaust outgoing-flow duct being wholly within the second end of the exhaust incoming-flow duct, the first end of the exhaust incoming-flow duct being wholly outside of the exhaust outgoing-flow duct.

Example 6 includes the turbocharger assembly of any of Examples 1-5, in which the air incoming-flow duct includes a mid-portion between the first end of the air incoming-flow duct and the second end of the air incoming-flow duct that has a non-circular cross-section; and in which the air outgoing-flow duct extends from a first end of the air outgoing-flow duct to a second end of the air outgoing-flow duct, the second end of the air outgoing-flow duct being wholly within the second end of the air incoming-flow duct, the first end of the air outgoing-flow duct being wholly outside of the air incoming-flow duct.

Example 7 includes a turbine assembly for a turbocharger, the turbine assembly comprising: a turbine wheel configured to rotate about an axis of rotation, the turbine wheel being coupled to an output shaft configured to drive a compressor; an exhaust incoming-flow duct configured to receive exhaust gases from an exhaust manifold of an engine at a first end of the exhaust incoming-flow duct and to deliver the exhaust gases at a second end of the exhaust incoming-flow duct to the turbine wheel in an annular flow-path and in a first direction that is substantially parallel to the axis of rotation, the annular flow-path being an annular-flow-path portion of the exhaust incoming-flow duct; and the turbine wheel having turbine blades configured to accept the exhaust gases from the exhaust incoming-flow duct, redirect the exhaust gases, and discharge the exhaust gases along an exhaust outgoing-flow duct in a second direction that is substantially opposite to the first direction, the exhaust outgoing-flow duct passing radially inside of an inner boundary of the annular-flow-path portion of the exhaust incoming-flow duct.

Example 8 includes the turbine assembly of Example 7, further comprising a catalytic converter within the exhaust incoming-flow duct.

Example 9 includes the turbine assembly of any of Examples 7-8, further comprising a catalytic converter between the first end of the exhaust incoming-flow duct and the exhaust manifold of the engine.

Example 10 includes the turbine assembly of any of Examples 7-9, in which the turbine wheel is coupled to a shaft, the shaft coinciding with the axis of rotation.

Example 11 includes the turbine assembly of Example 10, further comprising a motor coupled to the shaft, the motor configured to rotate the shaft and, thereby, rotate the turbine wheel.

Example 12 includes the turbine assembly of any of Examples 7-11, in which the exhaust outgoing-flow duct includes a mid-portion between the first end of the exhaust outgoing-flow duct and the second end of the exhaust outgoing-flow duct that has a non-circular cross-section; and in which the exhaust incoming-flow duct extends from a first end of the exhaust incoming-flow duct to a second end of the exhaust incoming-flow duct, the second end of the exhaust outgoing-flow duct being wholly within the second end of the exhaust incoming-flow duct, the first end of the exhaust incoming-flow duct being wholly outside of the exhaust outgoing-flow duct.

Example 13 includes the turbine assembly of Example 12, in which the non-circular cross-section of the mid-portion is substantially elliptical.

Example 14 includes the turbine assembly of any of Examples 12-13, in which a width of the mid-portion of the exhaust outgoing-flow duct in a third direction is less than a width of the mid-portion of the exhaust outgoing-flow duct in a fourth direction, the third direction being substantially perpendicular to the fourth direction.

Example 15 includes a compressor assembly for a turbocharger, the compressor assembly comprising: an impeller wheel configured to rotate about an axis of rotation, the impeller wheel being coupled to an input shaft configured to be driven by a turbine wheel; an air incoming-flow duct configured to receive air at a first end of the air incoming-flow duct and to deliver the air at a second end of the air incoming-flow duct to the impeller wheel in a first direction that is substantially parallel to the axis of rotation; and the impeller wheel having impeller blades configured to accept the air from the air incoming-flow duct, compress and redirect the air, and discharge the air along an air outgoing-flow duct in an annular flow-path in a second direction that is substantially opposite to the first direction, the annular flow-path being an annular-flow-path portion of the air outgoing-flow duct, the air incoming-flow duct passing radially inside of an inner boundary of the annular-flow-path portion of the air outgoing-flow duct.

Example 16 includes the compressor assembly of Example 15, further comprising an air filter at the first end of the air incoming-flow duct.

Example 17 includes the compressor assembly of any of Examples 15-16, further comprising a motor coupled to the shaft, the motor configured to rotate the shaft and, thereby, rotate the impeller wheel.

Example 18 includes the compressor assembly of any of Examples 15-17, in which the air incoming-flow duct includes a mid-portion between the first end of the air incoming-flow duct and the second end of the air incoming-flow duct that has a non-circular cross-section; and in which the air outgoing-flow duct extends from a first end of the air outgoing-flow duct to a second end of the air outgoing-flow duct, the second end of the air outgoing-flow duct being wholly within the second end of the air incoming-flow duct, the first end of the air outgoing-flow duct being wholly outside of the air incoming-flow duct.

Example 19 includes the compressor assembly of Example 18, in which the non-circular cross-section of the mid-portion is substantially elliptical.

Example 20 includes the compressor assembly of any of Examples 18-19, in which a width of the mid-portion of the air incoming-flow duct in a third direction is less than a width of the mid-portion of the air incoming-flow duct in a fourth direction, the fourth direction being substantially perpendicular to the third direction.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

Also, directions such as “right” and “left” are used for convenience and in reference to the views provided in figures. But the turbocharger may have a number of orientations in actual use. Thus, a feature that is to the right or to the left in the figures may not have that same orientation or direction in actual use.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or we) claim:

1. A turbocharger assembly comprising:
a turbine assembly comprising:
a turbine wheel configured to rotate about an axis of rotation,
an exhaust incoming-flow duct configured to receive exhaust gases from an exhaust manifold of an engine at a first end of the exhaust incoming-flow duct and to deliver the exhaust gases at a second end of the exhaust incoming-flow duct to the turbine wheel in an annular flow-path and in a first direction of the turbine assembly that is substantially parallel to the axis of rotation, the annular flow-path being at an annular-flow-path portion of the exhaust incoming-flow duct, and
the turbine wheel having turbine blades configured to accept the exhaust gases from the exhaust incoming-flow duct, redirect the exhaust gases, and discharge the exhaust gases along an exhaust outgoing-flow duct in a second direction of the turbine assembly that is substantially opposite to the first direction of the turbine assembly, the exhaust outgoing-flow duct passing radially inside of an inner boundary of the annular-flow-path portion of the exhaust incoming-flow duct;
a rotating shaft coupled to the turbine wheel, the rotating shaft coinciding with the axis of rotation; and
a compressor assembly comprising:
an impeller wheel configured to rotate about the axis of rotation, the impeller wheel being coupled to the rotating shaft,
an air incoming-flow duct configured to receive air at a first end of the air incoming-flow duct and to deliver the air at a second end of the air incoming-flow duct to the impeller wheel in a first direction of the compressor assembly that is substantially parallel to the axis of rotation, and
the impeller wheel having impeller blades configured to accept the air from the air incoming-flow duct, compress and redirect the air, and discharge the air along an air outgoing-flow duct in an annular flow-path in a second direction of the compressor assembly that is substantially opposite to the first direction of the compressor assembly, the annular flow-path being at an annular-flow-path portion of the air outgoing-flow duct, the air incoming-flow duct passing radially inside of an inner boundary of the annular-flow-path portion of the air outgoing-flow duct.

2. The turbocharger assembly of claim 1, further comprising a catalytic converter within the exhaust incoming-flow duct.

3. The turbocharger assembly of claim 1, further comprising a catalytic converter between the first end of the exhaust incoming-flow duct and the exhaust manifold of the engine.

4. The turbocharger assembly of claim 1, further comprising a motor coupled to the rotating shaft, the motor configured to rotate the rotating shaft and, thereby, rotate the turbine wheel.

5. The turbocharger assembly of claim 1:
in which the exhaust outgoing-flow duct includes a mid-portion between the first end of the exhaust outgoing-flow duct and the second end of the exhaust outgoing-flow duct that has a non-circular cross-section; and
in which the exhaust incoming-flow duct extends from a first end of the exhaust incoming-flow duct to a second end of the exhaust incoming-flow duct, the second end of the exhaust outgoing-flow duct being wholly within the second end of the exhaust incoming-flow duct, the first end of the exhaust incoming-flow duct being wholly outside of the exhaust outgoing-flow duct.

6. The turbocharger assembly of claim 1:
in which the air incoming-flow duct includes a mid-portion between the first end of the air incoming-flow duct and the second end of the air incoming-flow duct that has a non-circular cross-section; and
in which the air outgoing-flow duct extends from a first end of the air outgoing-flow duct to a second end of the air outgoing-flow duct, the second end of the air outgoing-flow duct being wholly within the second end of the air incoming-flow duct, the first end of the air outgoing-flow duct being wholly outside of the air incoming-flow duct.

7. A turbine assembly for a turbocharger, the turbine assembly comprising:
a turbine wheel configured to rotate about an axis of rotation, the turbine wheel being coupled to an output shaft configured to drive a compressor;
an exhaust incoming-flow duct configured to receive exhaust gases from an exhaust manifold of an engine at a first end of the exhaust incoming-flow duct and to deliver the exhaust gases at a second end of the exhaust incoming-flow duct to the turbine wheel in an annular flow-path and in a first direction that is substantially parallel to the axis of rotation, the annular flow-path being an annular-flow-path portion of the exhaust incoming-flow duct; and
the turbine wheel having turbine blades configured to accept the exhaust gases from the exhaust incoming-flow duct, redirect the exhaust gases, and discharge the exhaust gases along an exhaust outgoing-flow duct in a second direction that is substantially opposite to the first direction, the exhaust outgoing-flow duct passing radially inside of an inner boundary of the annular-flow-path portion of the exhaust incoming-flow duct.

8. The turbine assembly of claim 7, further comprising a catalytic converter between the second end of the exhaust incoming-flow duct and the turbine wheel.

9. The turbine assembly of claim 7, further comprising a catalytic converter between the first end of the exhaust incoming-flow duct and the exhaust manifold of the engine.

10. The turbine assembly of claim 7, in which the turbine wheel is coupled to a shaft, the shaft coinciding with the axis of rotation.

11. The turbine assembly of claim 10, further comprising a motor coupled to the shaft, the motor configured to rotate the shaft and, thereby, rotate the turbine wheel.

12. The turbine assembly of claim 7:
in which the exhaust outgoing-flow duct includes a mid-portion between the first end of the exhaust outgoing-flow duct and the second end of the exhaust outgoing-flow duct that has a non-circular cross-section; and
in which the exhaust incoming-flow duct extends from a first end of the exhaust incoming-flow duct to a second end of the exhaust incoming-flow duct, the second end of the exhaust outgoing-flow duct being wholly within the second end of the exhaust incoming-flow duct, the first end of the exhaust incoming-flow duct being wholly outside of the exhaust outgoing-flow duct.

13. The turbine assembly of claim 12, in which the non-circular cross-section of the mid-portion is substantially elliptical.

14. The turbine assembly of claim 12, in which a width of the mid-portion of the exhaust outgoing-flow duct in a third direction is less than a width of the mid-portion of the exhaust outgoing-flow duct in a fourth direction, the third direction being substantially perpendicular to the fourth direction.

15. A compressor assembly for a turbocharger, the compressor assembly comprising:
an impeller wheel configured to rotate about an axis of rotation, the impeller wheel being coupled to an input shaft configured to be driven by a turbine wheel;
an air incoming-flow duct configured to receive air at a first end of the air incoming-flow duct and to deliver the air at a second end of the air incoming-flow duct to the impeller wheel in a first direction that is substantially parallel to the axis of rotation; and
the impeller wheel having impeller blades configured to accept the air from the air incoming-flow duct, compress and redirect the air, and discharge the air along an air outgoing-flow duct in an annular flow-path in a second direction that is substantially opposite to the first direction, the annular flow-path being an annular-flow-path portion of the air outgoing-flow duct, the air incoming-flow duct passing radially inside of an inner boundary of the annular-flow-path portion of the air outgoing-flow duct.

16. The compressor assembly of claim 15, further comprising an air filter at the first end of the air incoming-flow duct.

17. The compressor assembly of claim 15, further comprising a motor coupled to the shaft, the motor configured to rotate the shaft and, thereby, rotate the impeller wheel.

18. The compressor assembly of claim 15:
in which the air incoming-flow duct includes a mid-portion between the first end of the air incoming-flow duct and the second end of the air incoming-flow duct that has a non-circular cross-section; and
in which the air outgoing-flow duct extends from a first end of the air outgoing-flow duct to a second end of the air outgoing-flow duct, the second end of the air outgoing-flow duct being wholly within the second end of the air incoming-flow duct, the first end of the air outgoing-flow duct being wholly outside of the air incoming-flow duct.

19. The compressor assembly of claim 18, in which the non-circular cross-section of the mid-portion is substantially elliptical.

20. The compressor assembly of claim 18, in which a width of the mid-portion of the air incoming-flow duct in a third direction is less than a width of the mid-portion of the air incoming-flow duct in a fourth direction, the fourth direction being substantially perpendicular to the third direction.
